(19) United States
(12) Patent Application Publication
(10) Pub. No.: US 2011/0089749 A1
(43) Pub. Date: Apr. 21, 2011

(54) VEHICLE WHEEL ASSEMBLY WITH GALVANIC ISOLATION

(75) Inventors: Richard M. Kleber, Clarkston, MI (US); Ravi Verma, Shelby Township, MI (US)

(73) Assignee: GM GLOBAL TECHNOLOGY OPERATIONS, INC., Detroit, MI (US)

(21) Appl. No.: 12/581,320

(22) Filed: Oct. 19, 2009

(51) Int. Cl. B60B 3/10; B23P 17/00; B60B 3/06

(52) U.S. Cl. 301/64.307; 29/894.325; 301/65

(57) ABSTRACT

Exemplary embodiments include a product and a method of galvanically isolating an outer wheel portion from a wheel hub. A center wheel portion may comprise a less galvanically active material than the outer wheel portion and may be attached to the outer wheel portion with an interlock.

### TECHNICAL FIELD

The technical field generally relates to products including motor vehicle wheels and methods of making them. More specifically, the technical field relates to preventing corrosion of motor vehicle wheels.

### BACKGROUND

Alloy wheels are commonly used on motor vehicles to reduce weight and to increase aesthetic appeal. Galvanic corrosion is a design consideration when mounting alloy wheels to wheel hubs that are often constructed from materials such as steel or iron that are different from the alloy wheel materials. These components spend much of their service life in wet conditions, often with road salt, which can promote galvanic corrosion.

### SUMMARY OF EXEMPLARY EMBODIMENTS OF THE INVENTION

One exemplary embodiment includes a product that may include a wheel assembly. The wheel assembly may include a center wheel portion comprising a first material and an outer wheel portion comprising a second material different from the first material. The center wheel portion may be attached to the outer wheel portion and may galvanically isolate the outer wheel portion from a wheel hub to which the center wheel portion is to be attached.

One exemplary embodiment includes a method that may include galvanically isolating an outer wheel portion from a wheel hub by attaching a center wheel portion to the outer wheel portion. The center wheel portion may extend radially past an edge of an interface defined by the center wheel portion and the outer wheel portion. The attaching may include forming an interlock between the center wheel portion and the outer wheel portion.

One exemplary embodiment includes a method that may include placing one of a center wheel portion and an outer wheel portion in a wheel casting die. The method may further include casting the other of the center wheel portion and the outer wheel portion to form an interlock between the center wheel portion and the outer wheel portion. The center wheel portion may comprise a first material and the outer wheel portion may comprise a second material. The first material may be less galvanically active than the second material.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a front view of an exemplary wheel assembly;

FIG. 2 is a cross-sectional view of an exemplary embodiment of a wheel assembly;

FIG. 3 is a cross-sectional view of an exemplary embodiment of a wheel assembly shown mounted to a wheel hub;

FIG. 4 is a perspective view of an exemplary center wheel portion;

FIG. 5 is a cross-sectional view of the exemplary center wheel portion of FIG. 4 shown attached to an outer wheel portion;

FIG. 6 is a perspective view of an exemplary center wheel portion;

FIG. 7 is a cross-sectional view of the exemplary center wheel portion of FIG. 6 shown attached to an outer wheel portion;

FIG. 8 is a perspective view of an exemplary center wheel portion;

FIG. 9 is a cross-sectional view of the exemplary center wheel portion of FIG. 8 shown attached to an outer wheel portion;

FIG. 10 is a perspective view of an exemplary center wheel portion;

FIG. 11 is a perspective a cross-sectional view of the exemplary center wheel portion of FIG. 10 shown attached to an outer wheel portion;

FIG. 12 is a cross-sectional view of an exemplary wheel casting die; and

FIG. 13 is a cross-sectional view of an exemplary wheel casting die.

### DETAILED DESCRIPTION OF EXEMPLARY EMBODIMENTS

The following description of the embodiments is merely exemplary in nature and is in no way intended to limit the invention, its application, or its uses.

The figures illustrate exemplary embodiments of a wheel assembly 10, methods of making the wheel assembly 10, and exemplary embodiments of a center wheel portion 12 that the wheel assembly 10 can comprise.

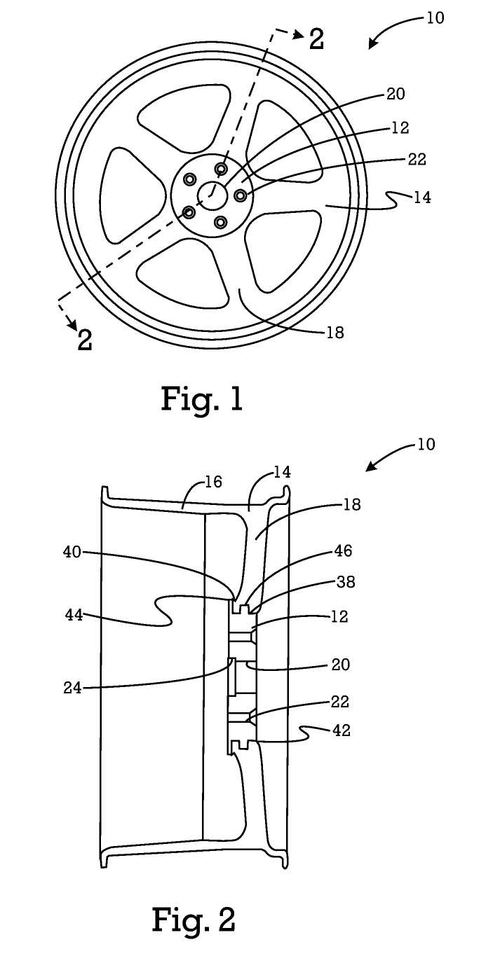

Referring to FIG. 1, the wheel assembly 10 may generally include the center wheel portion 12 and an outer wheel portion 14. The outer wheel portion 14 may include a rim 16 and may also include one or more spokes 18 extending from the rim 16 in a generally radial direction toward the center wheel portion 12. The center wheel portion 12 may include a center opening 20 and may define one or more lug holes 22 for attaching the wheel assembly 10 to a vehicle.

Referring to FIG. 2, the wheel assembly 10 may have an inboard side and an outboard side. The inboard side generally indicates the side of the wheel assembly 10 that faces the vehicle, and the outboard side generally indicates the side of the wheel assembly 10 that faces away from the vehicle when the wheel assembly 10 is attached to the vehicle. The center wheel portion 12 may be attached to the outer wheel portion 14 and may include a pilot bore 24 on its inboard side.

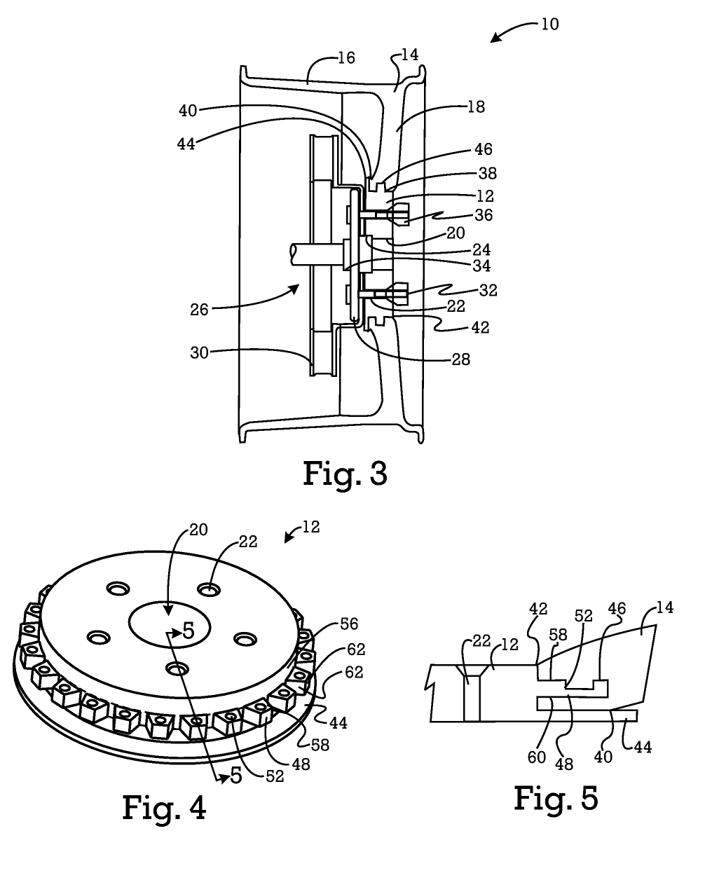

Referring to FIG. 3, the wheel assembly 10 may be attached to the wheel hub 26 of the vehicle. The wheel hub 26 may include various components such as a wheel spindle 28, a brake rotor 30, and one or more lug bolts 32. The wheel hub 26 may of course include various other components not shown. The wheel spindle 28 may include a pilot surface 34 to be received by the pilot bore 24 to help center the wheel assembly 10 on the wheel hub 26. The lug bolts 32 may be received by the lug holes 22 of the center wheel portion 12. One or more lug nuts 36 may be used in conjunction with the lug bolts 32 to attach the wheel assembly 10 to the wheel hub 26. The geometry of the center wheel portion 12 may be chosen so that none of the wheel hub components or the lug nuts 36 make direct physical contact with the outer wheel portion 14. This can facilitate galvanic isolation of the outer wheel portion 14 from the wheel hub 26.

When two or more different metals come into contact with one another in the presence of an electrolyte such as seawater, or other water that contains dissolved salts, a galvanic cell may be created. When a galvanic cell is created, the more galvanically active metal may corrode at a higher rate than it would alone or alone in the presence of the same electrolyte. This higher rate of corrosion of the more active metal is galvanic corrosion. One of the factors that can influence the rate of galvanic corrosion of metals is their relative position in a galvanic series as shown by way of example in Table I. Table I includes a list of common materials in order of their respective galvanic activity in seawater. The materials at the top of the list are more galvanically active, and the materials at the bottom of the list are less galvanically active (or more noble). The list is qualitative in nature and not quantitative; i.e., the relative distance from one material to another in the list is not necessarily proportional to the relative galvanic activity.

TABLE I
Galvanic Series

| Material | Relative Activity |
|---|---|
| Magnesium | More Active |
| Zinc | \| |
| Aluminum Alloys | \| |
| Cadmium | \| |
| Cast Irons | \| |
| Steel | \| |
| Aluminum Bronze | \| |
| Red, Yellow, Naval Brasses | \| |
| Copper | \| |
| 50-50 Lead-Tin Solder | \| |
| Admiralty Brass | \| |
| Manganese Bronze | \| |
| Silicon Bronze | \| |
| 400 Series Stainless Steels | \| |
| 90-10 Copper-Nickel | \| |
| Lead | \| |
| 70-30 Copper-Nickel | \| |
| Silver | \| |
| 300 Series Stainless Steels | \| |
| Titanium and Titanium Alloys | \| |
| Platinum | ↓ |
| Graphite | Less Active |

The further apart two metals are in the galvanic series, the higher the corrosion rate of the more active metal when in contact with the less active metal in the presence of the electrolyte. For example, if magnesium and steel are in contact in the presence of the electrolyte, the magnesium will corrode at a higher rate than it will if magnesium and an aluminum alloy are in contact in the presence of the electrolyte. This is because magnesium and aluminum are closer to one another in the galvanic series than magnesium and steel. As an additional example, the magnesium would corrode at an even higher rate if coupled with copper in the presence of the electrolyte.

Referring again to FIG. 3, the center wheel portion 12 may be constructed from a first material, and the outer wheel portion 14 may be constructed from a second material that may be different from the first material. In one embodiment, the first material may be less galvanically active than the second material. The geometry of the center wheel portion 12 may be selected so that the center wheel portion 12 galvanically isolates the outer wheel portion 14 from the wheel hub 26 when the center wheel portion 12 is attached to the wheel hub 26. The center wheel portion 12 may galvanically isolate the outer wheel portion 14 from the wheel hub 26 by preventing the outer wheel portion 14 and the wheel hub 26 from contacting one another. By selecting different materials for the center wheel portion 12 and the outer wheel portion 14, galvanic corrosion may be selectively controlled among the various components of the wheel assembly 10 and the wheel hub 26.

For example, the center wheel portion 12 may comprise aluminum or an aluminum alloy, and the outer wheel portion 14 may comprise magnesium or a magnesium alloy. One or more of the components of the wheel hub 26 may comprise steel or cast iron. By galvanically isolating the outer wheel portion 14 from the wheel hub 26 with the center wheel portion 12 as described, the rate of corrosion of the outer wheel portion 14 can thus be reduced to a rate less than the rate of corrosion that would result if the entire wheel assembly 10 was constructed from the second material. This can allow wheel designers to use materials having relatively high galvanic activities while lessening the concern of galvanic corrosion. Of course, other material combinations may be used. For example, the first material may comprise zinc or cadmium when the second material comprises magnesium and the wheel hub 26 comprises steel or cast iron. Or the first material may comprise one or more electrically insulating materials such as ceramic or polymeric materials. Other considerations may influence choice of materials, such as strength, cost, and manufacturability, among others.

Referring again to FIG. 2 and FIG. 3, the center wheel portion 12 and the outer wheel portion 14 may define an interface 38 where the two portions are in contact with one another. The interface 38 may include an inboard edge 40 and an outboard edge 42. The center wheel portion 12 may include an extension 44 that extends radially beyond the inboard edge 40 of the interface 38. The extension 44 may prevent electrolytes from collecting and forming contact between the outer wheel portion 14 and the wheel hub 26, thereby further preventing creation of a galvanic cell between the outer wheel portion 14 and the wheel hub 26.

The wheel assembly 10 may include an interlock 46 to attach the center wheel portion 12 to the outer wheel portion 14. The interlock 46 may be generally located at the interface 38. The interlock 46 may generally include a plurality of features to attach the outer wheel portion 14 to the center wheel portion 12 and to prevent relative movement of the two portions in the axial, radial, and circumferential directions or to prevent detachment of the outer wheel portion 14 from the center wheel portion 12. Referring to FIGS. 4 through 11, the features may include various combinations of protrusions 48, recesses 50, apertures 52, and grooves 54, for example. The center wheel portion 12 may include one of more these types of features, and the outer wheel portion 14 may include one of more of these types of features. Generally, where the center wheel portion 12 includes one feature such as a protrusion 48, the outer wheel portion 14 may include a corresponding feature such as a recess 50 or aperture 52. FIGS. 4 through 11 illustrate various embodiments of the center wheel portion 12 that include one or more of these features from which the interlock 46 may be comprised.

Referring to FIG. 4, one embodiment of the center wheel portion 12 may include a plurality of protrusions 48. The protrusions 48 may extend generally radially from an outer surface 56 of the center wheel portion 12. The outer surface 56 may be generally annular, as shown, but may take a variety of shapes. Each protrusion 48 may include one or more surfaces including an inboard surface 58, an outboard surface 60, and various side surfaces 62. It is possible for each protrusion 48 to have a single continuous surface, such as if the protrusion 48 comprises a round or oval cross-section, for example. Each protrusion 48 may include one or more apertures 52. The apertures 52 may extend at least partially through the protrusion 48 or may extend completely through the protrusion 48 to form a through hole. Apertures 52 may be provided in one or more of the protrusions 48. FIG. 5 illustrates a cross-section of the center wheel portion 12 of FIG. 4 attached to the outer wheel portion 14. The second material that comprises the outer wheel portion 14 may extend at least partially into at least one of the apertures 52. The aperture 52 illustrated in this embodiment is formed on the outboard surface 60 of the protrusion 48, but it may also be formed on the inboard surface 58 or other surface or surfaces of the protrusion 48.

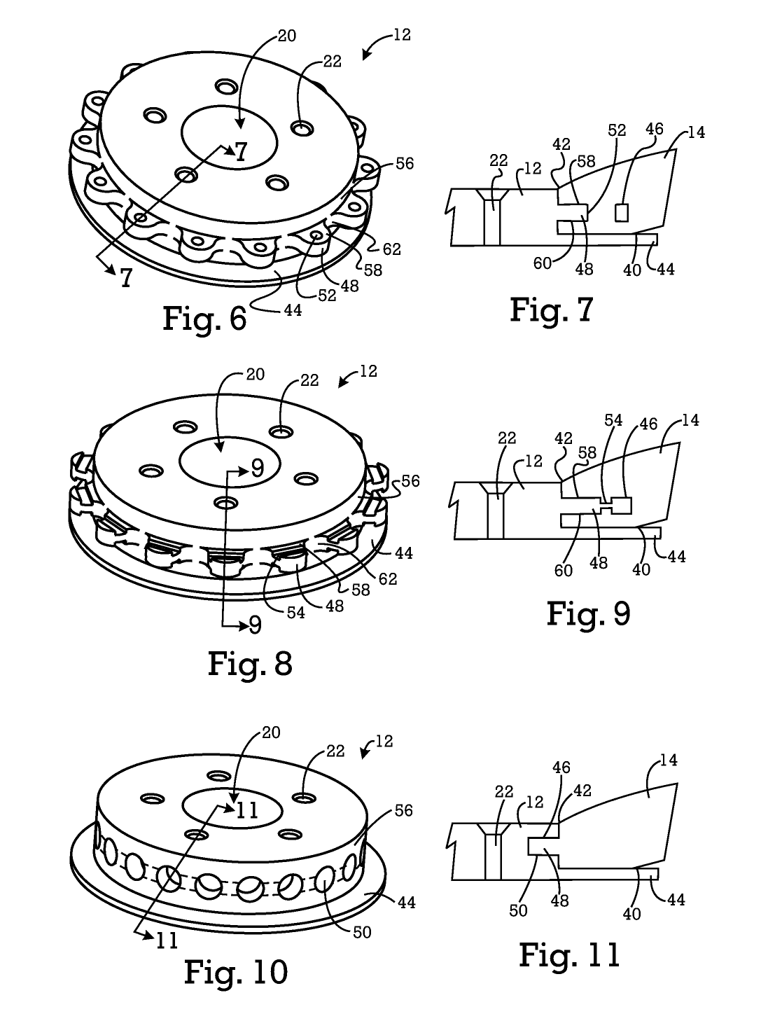

Referring to FIG. 6, the protrusions 48 may include the inboard surface 58, the outboard surface 60, and a continuous side surface 62. The side surface 62 may be in the shape of a continuous wave when viewed from the outboard side of the center wheel portion 12. FIG. 7 illustrates a cross-section of the center wheel portion 12 of FIG. 6 attached to the outer wheel portion 14 and illustrates apertures 52 in the form of through holes that may be included in the protrusions 48. Each through hole may extend from the inboard surface 58 to the outboard surface 60 of the protrusion 48, or may extend to or from other surfaces of each protrusion 48.

Referring to FIG. 8, the protrusions 48 may include one or more grooves 54 in one or more of their respective surfaces. The grooves 54 may extend in a generally circumferential direction, as shown, or may extend in other directions. The grooves 54 may be formed in the outboard surface 60 of the protrusions 48 or may be formed in the inboard surface 58 or the side surface(s) 62 of the protrusions 48 or in any combination of the surfaces of the protrusions 48. FIG. 9 illustrates a cross-section of the center wheel portion 12 of FIG. 8 attached to the outer wheel portion 14 and illustrates the grooves 54 formed in the inboard and the outboard surfaces of the protrusion 48.

Referring to FIG. 10, the center wheel portion 12 may include a plurality of recesses 50. The recesses 50 may be formed in the outer surface 56 of the center wheel portion 12. The recesses 50 may extend generally radially into the outer surface 56. The recesses 50 may have a generally circular cross-section, as shown, or they may have cross-sections in other shapes. FIG. 11 illustrates a cross-section of the center wheel portion 12 of FIG. 10 attached to the outer wheel portion 14. The second material that comprises the outer wheel portion 14 may extend at least partially into at least one of the plurality of recesses 50. Another way to describe the interlock 46 depicted in FIG. 11 is that the outer wheel portion 14 may include a plurality of protrusions 48 that may extend in a generally radial direction at least partially into the recesses 50 formed in the center wheel portion 12.

In some embodiments, the center wheel portion 12 may include essentially only the extension 44. In yet other embodiments, the center wheel portion 12 may include a first piece being the extension 44 and a second piece that may make up the remainder of the center wheel portion 12.

These multiple examples of center wheel portions 12 are only some of the ways to form an interlock 46 to attach the center wheel portion 12 to the outer wheel portion 14. Various other interlocks 46 are possible. These exemplary center wheel portions 12 may be formed using a variety of manufacturing techniques including, but not limited to, die casting, forging, stamping, machining, or various combinations of these techniques. Additionally, the interlock 46 is only one way of attaching the center wheel portion 12 to the outer wheel portion 14. Various other types of attachments are contemplated, such as mechanical fasteners, welds, adhesives, interference fits, or others.

Consistent with the various exemplary descriptions of the wheel assembly 10, a method may be described that includes galvanically isolating the outer wheel portion 14 from the wheel hub 26. The method may include attaching the center wheel portion 12 to the outer wheel portion 14. The attaching step may include forming the interlock 46 between the center wheel portion 12 and the outer wheel portion 14. The center wheel portion 12 in this method may include the extension 44 that extends radially past the inboard edge 40 of the interface 38 defined by the center wheel portion 12 and the outer wheel portion 14. The center wheel portion 12 may also include a plurality of protrusions 48 extending therefrom or a plurality of recesses 50 formed therein. The protrusions 48 may include one or more apertures 52 at least partially therethrough. As previously described, the center wheel portion 12 may include essentially only the extension 44 in some embodiments. In yet other embodiments, the center wheel portion 12 may include a first piece being the extension 44 and a second piece that may make up the remainder of the center wheel portion 12. In one embodiment, the step of forming the interlock 46 may include casting the outer wheel portion 14 onto or around the center wheel portion 12. In another embodiment, the step of forming the interlock 46 may include casting the center wheel portion 12 onto or into the outer wheel portion 14. In still other embodiments, the attaching step may include attaching the center wheel portion 12 to the outer wheel portion 14 with mechanical fasteners or by joining operations such as welding, brazing, soldering, applying an adhesive to at least one of the center wheel portion 12 or the outer wheel portion 14, or other suitable techniques.

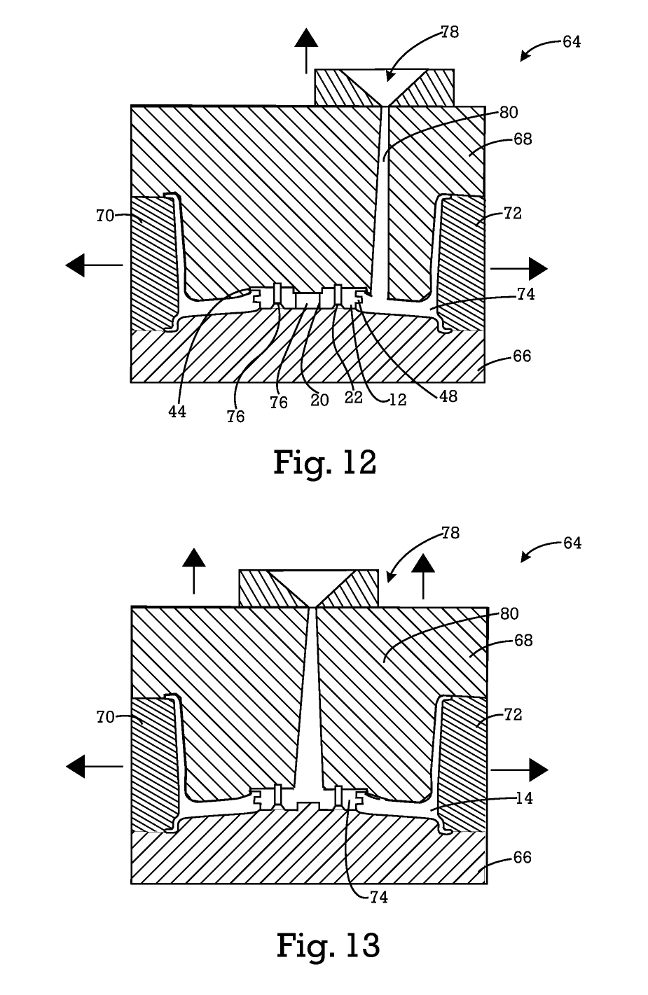

Referring to FIG. 12 and FIG. 13, a method can be described. In one embodiment, the method may include placing the center wheel portion 12 in a wheel casting die 64 and casting the outer wheel portion 14 onto or around the center wheel portion 12 to form the interlock 46 with the center wheel portion 12. In another embodiment, the method may include placing the outer wheel portion 14 in a wheel casting die 64 and casting the center wheel portion 12 onto or into the outer wheel portion 14 to form the interlock 46. As described previously, the center wheel portion 12 may comprise the first material and the outer wheel portion 14 may comprise the second material, and the first material may be less galvanically active than the second material. For example, the first material may comprise aluminum, and the second material may comprise magnesium, though several other material combinations are possible. The wheel casting die 64 may include various components including a lower portion 66, an upper portion 68, a left side 70, and a right side 72. The die 64 is shown in cross-section in a closed position. The upper portion 68 may be movable in an upward direction to place the die 64 in an open position. Likewise, the left side 70 and the right side 72 may be moveable in left and right directions, respectively, to place the die 64 in the open position. When in the closed position, the die 64 defines a cavity 74 that may be generally shaped in the form of the desired wheel assembly 10. The die 64 may of course include various other components not shown.

In one embodiment, with the die 64 in the open position, the center wheel portion 12 may be placed in the die 64 and may rest on the lower portion 66 of the die 64. The lower portion 66 may include various locators 76 to center and properly index the center wheel portion 12 with respect to the cavity 74. The locators 76 may be received by features of the center wheel portion 12 such as the center opening 20, the lug holes 22, or other features. The die 64 can then be placed in the closed position by moving the upper portion 68, the left side 70, and the right side 72 into their corresponding closed positions. The casting step may include introducing the second material, in liquid or molten form, to a material inlet 78 that may be located above the upper portion 68 of the die 64. The material inlet 78 may be fluidly connected to the cavity 74 by a runner 80 that extends through the upper portion 68 of the die 64. Thus, second material can flow into the cavity 74 through the runner 80. Once in the cavity 74, the second material may flow into any apertures 52 or recesses 50 formed in the center wheel portion 12 or formed in protrusions 48 that extend from the center wheel portion 12. When the cavity 74 is sufficiently filled, the second material may be allowed to cool and solidify. Thereafter, the die 64 may be placed in the open position and the wheel assembly 10 can be removed from the lower portion 66 of the die 64.

In another embodiment, best illustrated in FIG. 13, the outer wheel portion 14 may be placed in the die 64 while in the open position. The die 64 can then be placed in the closed position as described previously. The casting step may include introducing the first material, in liquid or molten form, to the material inlet 78 to allow the first material to flow into the cavity 74 through the runner 80. Once in the cavity 74, the first material may flow into any apertures or recesses formed in the outer wheel portion 14. When the cavity 74 is sufficiently filled, the first material may be allowed to cool and solidify. Thereafter, the die 64 may be placed in the open position and the wheel assembly 10 can be removed from the lower portion 66 of the die 64.

Additional processing operations such as machining may be employed to remove portions of the first or second material, particularly any of the first or second material that solidified in the runner 80 during cooling. Also, some of the second material may be removed from the inboard side of the outer wheel portion 14 to allow the center wheel portion 12 to extend the desired radial distance past the edge of the interface 38 defined by the center wheel portion 12 and the outer wheel portion 14. In some embodiments, such as those in which the center wheel portion 12 is cast onto or into the outer wheel portion 14, additional processing operations such as machining may be employed to remove some of the first material to form the pilot bore 24 of the center wheel portion after casting and after removing material that may have solidified in the runner 80.

The casting process described above may be a traditional gravity-fed casting process. Other casting processes may be used, such as squeeze-casting where the material being cast is pressurized. It may also be possible to cast the outer wheel portion 14 or the center wheel portion 12 by other techniques, such as powder metallurgy techniques where the first or second material may be in powder form, placed in the cavity 74, subjected to very high pressure, and sintered.

The selection of the first and second materials utilized in the described methods may be based on several considerations, including but not limited to their relative galvanic activity, their relative melting points, cost, weight, aesthetics, and suitability for the particular manufacturing processes of the embodiment or embodiments being practiced.

The above description of embodiments of the invention is merely exemplary in nature and, thus, variations thereof are not to be regarded as a departure from the spirit and scope of the invention.

What is claimed is:

1. A product comprising:
a wheel assembly comprising a center wheel portion comprising a first material; and
an outer wheel portion comprising a second material different from the first material, wherein the center wheel portion is attached to the outer wheel portion and galvanically isolates the outer wheel portion from a wheel hub to which the wheel assembly is to be attached.

2. The product of claim 1 further comprising an interlock to attach the center wheel portion to the outer wheel portion.

3. The product of claim 2 wherein the interlock comprises a plurality of protrusions extending from the center wheel portion.

4. The product of claim 3 further comprising at least one aperture at least partially through at least one of the protrusions.

5. The product of claim 2 wherein the interlock comprises a plurality of recesses in the center wheel portion.

6. The product of claim 1 wherein the first material comprises aluminum.

7. The product of claim 1 wherein the second material comprises magnesium.

8. The product of claim 1 wherein the first material is less galvanically active than the second material.

9. The product of claim 8 wherein the second material comprises magnesium.

10. The product of claim 1 wherein the center wheel portion further comprises an extension that extends radially beyond an edge of an interface defined by the center wheel portion and the outer wheel portion.

11. The product of claim 4 wherein the second material extends at least partially into the at least one aperture.

12. The product of claim 5 wherein the second material extends at least partially into at least one of the plurality of recesses.

13. The product of claim 1 wherein the first material comprises an aluminum alloy and the second material comprises a magnesium alloy.

14. A method comprising:
galvanically isolating an outer wheel portion from a wheel hub by attaching a center wheel portion to the outer wheel portion, wherein the center wheel portion extends radially past an edge of an interface defined by the center wheel portion and the outer wheel portion, and wherein the attaching comprises forming an interlock between the center wheel portion and the outer wheel portion.

15. The method of claim 14 wherein the outer wheel portion comprises magnesium.

16. The method of claim 14 wherein the center wheel portion comprises a plurality of protrusions and the step of forming an interlock comprises casting the outer wheel portion onto the center wheel portion or casting the center wheel portion onto the outer wheel portion.

17. A method comprising:
placing one of a center wheel portion and an outer wheel portion in a wheel casting die;
casting the other of the center wheel portion and the outer wheel portion to form an interlock between the center wheel portion and the outer wheel portion;
wherein the center wheel portion comprises a first material, the outer wheel portion comprises a second material, and the first material is less galvanically active than the second material.

18. The method of claim 17 wherein the interlock comprises at least one protrusion defined by the center wheel portion or the outer wheel portion.

19. The method of claim 17 wherein the second material flows into apertures or recesses in the center wheel portion or the first material flows into apertures or recesses in the outer wheel portion during the casting step.

20. The method of claim 17 wherein the second material comprises magnesium.
